(19) United States
(12) Patent Application Publication
(10) Pub. No.: US 2009/0179779 A1
(43) Pub. Date: Jul. 16, 2009

(54) Identification apparatus and identification method

(75) Inventors: Osamu Katayama, Nagoya-city (JP); Yasuji Inobe, Nagoya-city (JP); Naoki Saiwaki, Nara-city (JP)

Correspondence Address: POSZ LAW GROUP, PLC, 12040 SOUTH LAKES DRIVE, SUITE 101, RESTON, VA, 20191, US

(73) Assignees: DENSO CORPORATION, Kariya-city (JP); NARA WOMEN'S UNIVERSITY, Nara-city (JP)

(21) Appl. No.: 12/314,866

(22) Filed: Dec. 18, 2008

(30) Foreign Application Priority Data
Jan. 11, 2008 (JP) 2008-4441

(51) Int. Cl. H03M 11/00; H04L 9/00

(52) U.S. Cl. 341/22; 713/183

(57) ABSTRACT

An identification apparatus and an identification method are disclosed. According to the identification apparatus and method, an identification code is created by combining multiple information items. Further one or more of multiple tactile information items that represents the created identification code is produced based on a correspondence relation between the multiple tactile information items and the multiple information units. Further, identification is performed based on determining whether the created identification code is equal to the identification code that is actually input in response to the producing of the one or more of the multiple tactile information items that represents the created identification code.

### CROSS REFERENCE TO RELATED APPLICATION

The present application is based on Japanese Patent Application No. 2008-4441 filed on Jan. 11 2008, the disclosure of which is incorporated herein by reference.

### BACKGROUND OF THE INVENTION

1. Field of the Invention

The present invention relates to an identification apparatus and an identification method.

2. Description of Related Art

There is known an identification apparatus for identifying a user through a user's input of a pre-registered identification code. For example, a user of an automate teller machine (ATM) inputs a four-digits personal identification number (PIN) by using numeric keys for numerals 0 to 9. Such an identification apparatus involves the following difficulty. If a stranger discovers the PIN by surreptitiously watching a key operation, it becomes possible for the stranger to be successfully identified as a proper user.

To address such a difficulty, an input apparatus described as follows has been proposed (cf. JP-A-2004-46548). When a numeric key is held down for a predetermined period to input a corresponding numeral, the numeral can be input predetermined times during the predetermined period, and further, vibration of a vibrator notifies a user of the number of numeral inputs. According to the above input apparatus, when the numerals in adjacent digits are entered by holding down the numeric key, it becomes difficult for a stranger to recognize, by surreptitiously watching, how often the numeral is input. Guess of the PIN code through a key operation becomes difficult.

According to the configuration disclosed in JP-A-2004-46548, however, the PIN code needs to include identical numerals in the adjacent digits in order to prevent from a stranger from discovering a PIN code. PIN code flexibility is therefore remarkably restricted, and the PIN code may become long.

### SUMMARY OF THE INVENTION

In view of the above and other points, it is an objective of the present invention to provide an identification apparatus and an identification method.

According to a first aspect of the present invention, an identification apparatus is provided. The identification apparatus includes an input unit that is capable of receiving an input operation. The identification apparatus further includes a tactile producing unit that is capable of producing multiple tactile information items different from each other. The identification apparatus further includes a memory unit that stores a correspondence relation between the multiple tactile information items and multiple information units. The identification apparatus further includes a code creation unit that is capable of creating an identification code, which is unfixed, by combining the multiple information units. The identification apparatus further includes a tactile generation unit that is configured to cause the tactile producing unit to produce one or more of the multiple tactile information items that represents the identification code created by the code creation unit, based on the correspondence relation stored in the memory unit. The identification apparatus further includes an identification unit that is configured to perform identification by determining whether the identification code that is created by the code creation unit is equal to the identification code that is actually input through the input unit in response to the produced one or more of the multiple tactile information items representing the identification code created by the code creation unit.

According to the above identification apparatus, it is possible to improve security.

According to a second aspect of the present invention, an identification method is provided. The identification method includes: creating a identification code, which is unfixed, by combining multiple information items; generating one or more of multiple tactile information items that represents the created identification code, based on a correspondence relation between the multiple tactile information items and the multiple information units; and performing identification by determining whether the created identification code is equal to the identification code that is actually input in response to the producing of the one or more of the multiple tactile information items that represents the created identification code.

According to the above identification method, it is possible to improve security.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram illustrating an identification apparatus in accordance with an example embodiment;

FIG. 2 is a table illustrating an example of a correspondence relation between tactile feeling items and numerals of 1 to 3 in accordance with an example embodiment;

FIG. 3 is a flow chart illustrating a registration procedure in accordance with an example embodiment;

FIG. 4 is a flow chart illustrating an identification procedure in accordance with an example embodiment;

FIG. 5 is a table illustrating another example of a correspondence relation between tactile feeling items and numerals of 1 to 10 in accordance with an example embodiment; and

FIG. 6 is a table illustrating values associate with controlling tactile actuators in accordance with an example embodiment.

### DETAILED DESCRIPTION OF THE EXEMPLARY EMBODIMENTS

Exemplary embodiments are described below with reference to the accompanying drawings.

### Example Embodiment

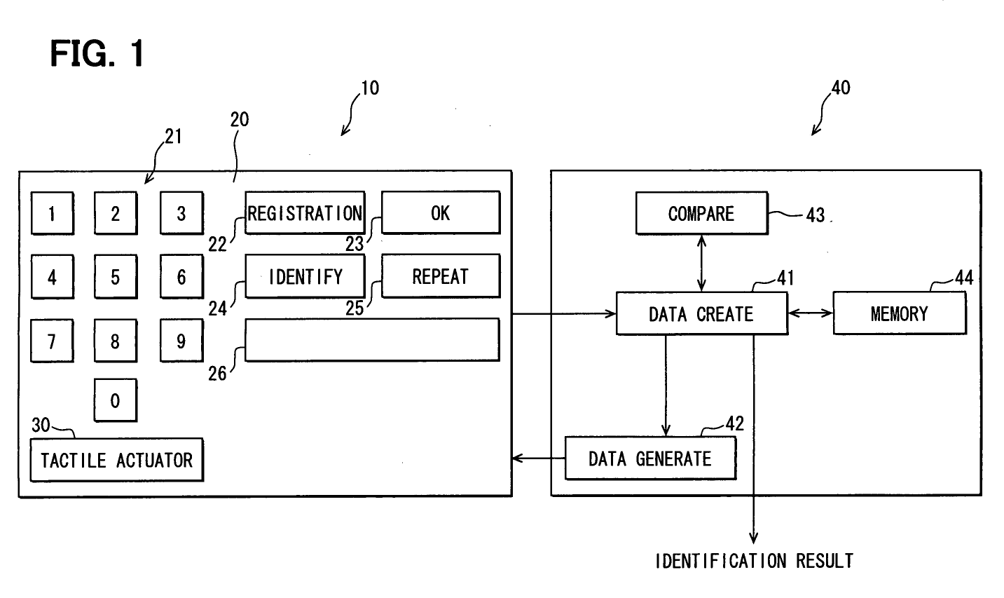

A configuration of an identification apparatus according to an example embodiment is explained below with reference to FIG. 1.

As shown in FIG. 1, the identification apparatus includes a display unit 10 and a control unit 40 (i.e., controller 40). The display unit 10 includes a monitor 20 and a tactile actuator 30. The monitor 20 has a touch-sensitive panel.

An operation key and an ID display window 26 are arranged in the monitor 20. The operation key has input keys (i.e., numeric keys) for a numeral 0 to a numeral 9, a registration key 22, an OK key 23, and an identification key 24. The ID display window 26 can display a user ID.

The identification apparatus according to an example embodiment uses a vibration device as the tactile actuator 30 for producing or presenting tactile feeling (i.e., tactile representation) through vibration. The control unit 40 includes a data creation unit 41, a data generation unit 42, a comparison unit 43 and a memory 44. More specifically, the control unit 40 is provided mainly by a micro computer having a CPU, a ROM and a RAM. The CPU performs various processes based on a program stored in the ROM, thereby to function as the above-described elements 41 to 44. Alternatively, hardware circuits provided separately may function as the data creation unit 41, the data generation unit 42, and the comparison unit 43.

Explanation is given below on processes performed by the control unit 40.

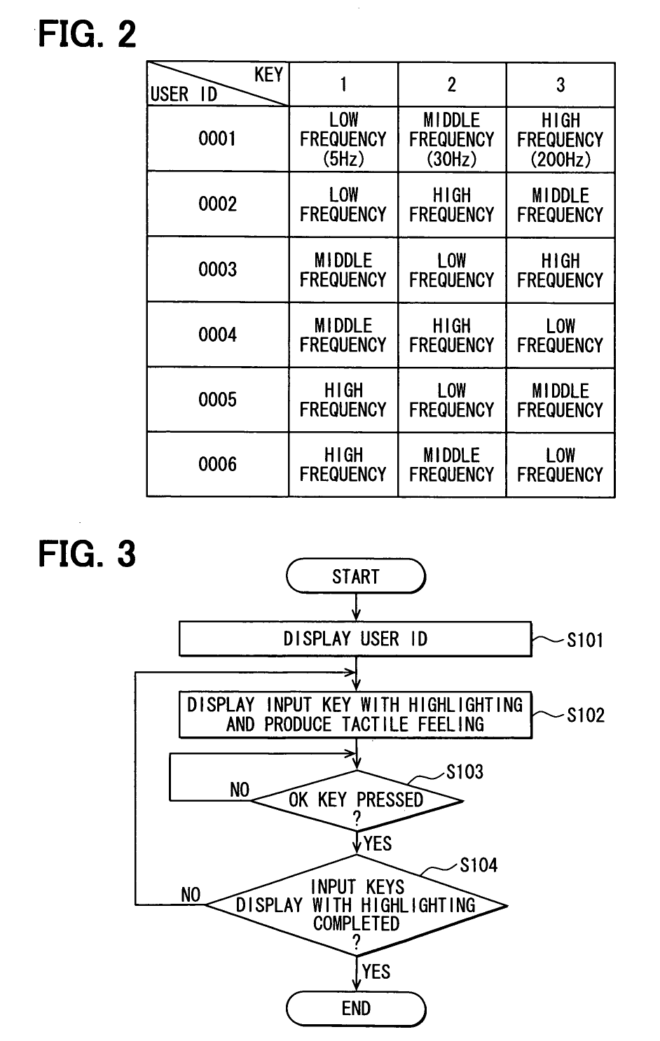

As shown in FIG. 2, for each of six user IDs (i.e., “0001” to “0006”), the memory 44 of the control unit 40 preliminarily stores a correspondence relations between numerals of “1” to “3” and three kinds of tactile feelings. The three kinds of tactile feeling are ones that the tactile actuator can provide, and are respectively associated with a low frequency vibration, a middle frequency vibration and a high frequency vibration. Setting is made such that different user IDs may refer to different correspondence relations. In a user registration, the identification apparatus notifies a user of a user ID and a correspondence relation for the ID. The identification apparatus identifies a user based on whether he or she is a person who knows the valid correspondence relation.

More specifically, a person who attempts to register himself or herself is requested to press the registration key 22 of the identification apparatus (see FIG. 1). When the registration key 22 is pressed, a signal indicating that the registration key 22 is pressed is input to the control unit 40. The data creation unit 41 sets a user ID for the user. The data generation unit 42 causes the display unit 10 to display the user ID (e.g., 0001) on the ID display window 26. Through the above manners, the user can recognize the user ID for himself or herself.

Then, the date generation unit 42 causes the display unit 10 to display with highlighting the input key 21 that corresponds to the numeral “1” while causing the tactile actuator 30 to produce the tactile feeling (e.g., a low frequency) that corresponds to the numeral “1”. When a user presses the OK key 23 in the above state, the data generation unit 42 causes the display unit 10 to display with highlighting the input key 21 that corresponds to the numeral “2” while causing the tactile actuator 30 to produce the tactile feeling (e.g., a middle frequency) that corresponds to the numeral “2”. When the user presses the OK key 23 in the above state, the data generation unit 42 causes the display unit 10 to display with highlighting the input key 21 that corresponds to the numeral “3” while causing the tactile actuator 30 to produce the tactile feeling (e.g., a high frequency) that corresponds to the numeral “3”. When the user presses the OK key 23 in the above state, the user registration is completed. Through the above manners, a user can recognize the tactile feelings that respectively correspond to the numerals of “1” to “3”. A user can recognize the correspondence relation for the user. A tactile feeling produced by the tactile actuator 30 can be discovered by only a person who is touching the tactile actuator 30, and cannot be discovered by surreptitiously watching. Therefore, a stranger is not able to discover the valid correspondence relation.

When a pre-registered user attempts to perform indemnification, the identification key 24 of the identification apparatus is requested to be pressed. Then, the user may enter his or her user ID by pressing the input keys 21. Information associated with the above input operation is inputted to the control unit 40. The data creation unit 41 creates, in a random manner, four-digits identification code (e.g., 3121), a numeral of each digit of which is 1, 2 or 3. The data generation unit 42 causes the tactile actuator 30 to successively produce the tactile feelings that represent the identification code. For example, the tactile feelings may be produced in the order of the high frequency, the low frequency, the middle frequency and the low frequency. Since, by only surreptitiously watching, one cannot discover the tactile feeling produced by the tactile actuator, a stranger cannot discover he presented identification code.

Then, by pressing the input keys 21, the user can enter the four-digits identification code (e.g., 3121) represented by the tactile feelings based on the valid correspondence relation that the user may memorize. The comparison unit 43 identifies the user based on determining whether the entered identification code is correct one or not. According to such an identification method, even if the input operation of the input keys 21 is surreptitiously watched, the correspondence relation for the user cannot be discovered by a stranger.

Explanation is more specifically given below on processes to be performed by a CPU of the control unit 40 to provide the above-described and other manners.

Referring to FIG. 3, explanation is given below on a registration procedure. The registration procedure is performed by the CPU when the registration key 22 is pressed. When the CPU starts the registration procedure, the CPU determines the user ID for a user and causes the ID display window to display the user ID, at S101. A single user ID may be assigned to a single user. Alternatively, a single user ID may be assigned to be multiple users (e.g., maximum 6 users in some cases).

At 102, the display unit 10 displays one of the input keys 21 with highlighting on the display windows. More specifically, the input key 21 for the numeral “1” is firstly displayed with highlighting. Then, when the process at S102 is performed again after return from S104, the CPU changes the input key 21 to be displayed with highlighting in the order of, for example, that for the numeral “2” and that for the numeral “3”. At S102, the tactile actuator 30 also produces the tactile feeling that corresponds to the numeral displayed with highlighting. In the above process, the CPU determines the tactile feeling that corresponds to the numeral, based on the stored correspondence relation for the user ID specified at the S101.

At S103, it is determined whether the OK key 23 is pressed or not. When it is determined that the OK key 23 is pressed, the procedure proceeds to S104. At S104, it is determined whether the displaying of the input keys for the numerals “1” to “3” is completed or not.

When it is determined at S104 that the displaying of the input keys for the numerals “1” to “3” are not completed, in other words, when it is determined that there remains the input key 21 that has not been displayed with highlighting, procedure returns to S102. Through the above manner, the display unit 10 displays the input keys 21 for the subsequent numerals with highlighting, and the tactile actuator 30 produces the tactile feelings that correspond to the subsequent numerals.

When it is determined at S104 that the displaying of the input keys for the numerals “1” to “3” is completed. The registration procedure is finished.

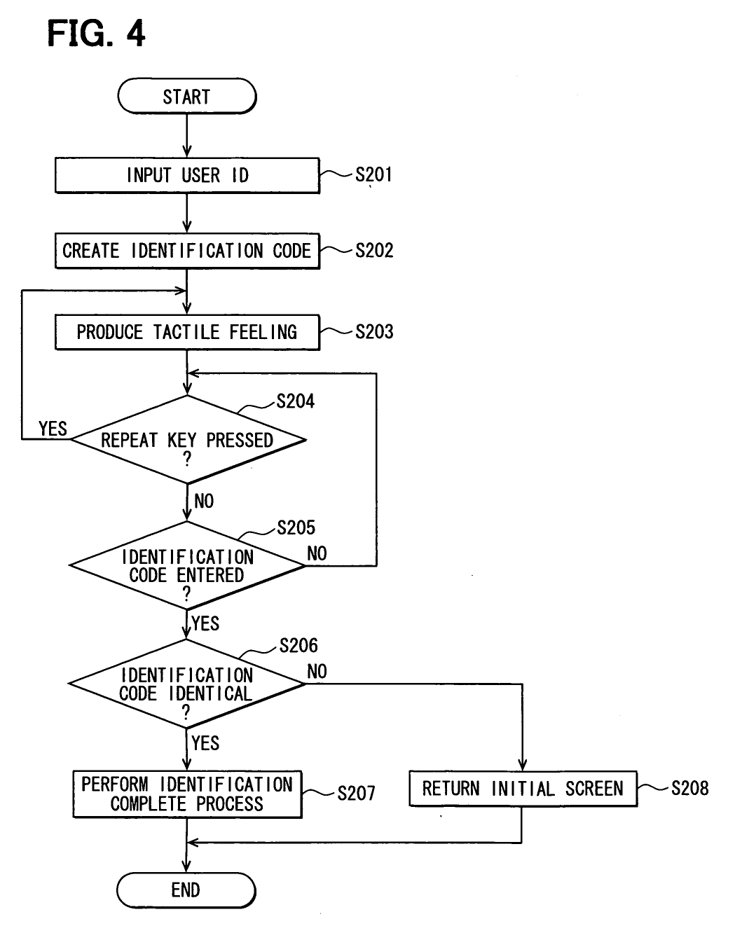

Referring to FIG. 4, explanation is given on an identification procedure that is performed by the CPU when the identification key 24 is pressed.

When the identification procedure starts, the CPU obtains a user ID through a user's input operation of the input keys 21. Then, at S202, the CPU randomly creates a four-digits identification code so that each digit is 1, 2, or 3.

At S203, the CPU causes the tactile actuator 30 to produce the tactile feelings that represent the identification code created at S202, based on the correspondence relation for the user ID inputted at S201. The tactile feelings that correspond to the four-digits number are successively produced in predetermined time intervals.

At S204, it is determined whether the repeat key 25 is pressed or not. When it is determined at S204 that the repeat key 25 is pressed, the procedure returns to S203 to produce again the tactile feelings that represent the identification code When it is determined at S204 that the repeat key 25 is not pressed, the procedure proceeds to S205 where it is determined whether the identification code is entered or not by pressing the input keys 21.

When it is determined at S205 that the identification code is not entered, the procedure returns to S204. When it is determined at S205 that the identification code is entered, the procedure proceeds to S206. At S206, it is determined whether the identification code that is entered by the user is consistent with the identification code that is created at S202.

When it is determined at S206 that the identification code that is entered by the user is correct, an identification completion process is performed. The identification completion process is, for example, outputting to an identification subject device an identification result indicating that the user is a valid person. Then, the identification procedure finishes.

When it is determined at S206 that the identification code that is entered by the user is incorrect, the procedure proceeds to S208 where an identification failure process is performed. The identification failure process is, for example, changing the display of the display unit to an initial screen. Then, the identification procedure finishes.

As described above, the identification apparatus according to an example embodiment creates a four-digits identification code by combining multiple informational units, each of which is “1”, “2” or “3” and is for use in providing the identification code. This process corresponds to S202. The tactile actuator 30 produces the tactile feelings (i.e., tactile information items) that represent the created identification code, based on the correspondence relation between the numerals of “1” to “3” and the tactile feelings that the tactile actuator 30 is capable of producing. This process corresponds to S203. The identification apparatus identifies a user based on determining whether the created identification code is consistent with the identification code that is entered by a user in response to the producing of the tactile feelings. This process corresponds to S206 to S208.

According to the above identification apparatus, it is possible to identify a user who knows the correct correspondence relation between the tactile feelings and the numerals. In particular, since a stranger cannot discover, by surreptitiously watching, the tactile feeling produced by the tactile actuator 30, even if a stranger surreptitiously watches the input operation of the identification code, the stranger is not able to discover the correspondence relation between the tactile feelings and the numerals. Accordingly, by performing identification using the identification code, it is possible to efficiently prevent a stranger from being successfully identified as a proper user. The identification code according to the present embodiment may be a dynamic or unfixed one, and may be dynamically created.

Since the identification apparatus creates a four-digits identification code by randomly combining the numerals of 1 to 3, it is difficult to estimate the correspondence relation between the tactile feelings and the numerals.

Further, since the identification apparatus stores the correspondence relations for multiple user IDs, the identification apparatus can identify multiple users based on different correspondence relations. Further, the identification apparatus successively displays the numerals “1” to “3” with highlighting in a user registration while the identification apparatus causes the tactile actuator 30 to produce the tactile feelings that correspond to the numerals. Accordingly, it is possible to notify a user of the correspondence relation between the tactile feelings and the numerals, so that the user is able to become the only person who knows the valid correspondence relation.

According to an aspect of an example embodiment: the monitor 20 of the display unit 10 can function as an input means or unit, and also can function as an information display means or unit; the tactile actuator 30 can function as a tactile producing means or unit; and the memory 44 can function as a memory means or unit. Further, the CPU capable of performing such processes S102 to S104 exemplified in FIG. 3 can function as a correspondence notification means or unit. Further, the CPU capable of performing such a process S202 exemplified in FIG. 4 can function as a code creation means or unit. The CPU capable of performing such a process S203 exemplified in FIG. 4 can function as a tactile generation means or unit. Further, the CPU capable of performing processes of S206 to S208 exemplified in FIG. 4 can function as an identification means or unit.

[Modifications]

An example embodiment can be modified in various ways. Examples of modifications are described below.

According to the above embodiment, the identification apparatus creates a four-digits identification codes so that each digit is “1”, “2” or “3”. The numerals “1”, “2” and “3” respectively correspond to the tactile feelings that the tactile actuator 30 is capable of producing. In such a case, since the correspondence relation has up to six different maps, it may be difficult to treat many users unless the same user ID is assigned to multiple users. In view of the above, the identification code may have more than four-digits. However, a longer identification code may complicate an operation. Alternatively, the tactile actuator 30 may produce more than three kinds of tactile feelings.

A method of producing a complex tactile feeling (e.g., a cloth touch feeling) by combining vibrations with different frequencies has been proposed in recent studies. Further, such an actuator has been studied that utilizes driving a pin upwardly and downwardly, electric stimulus, ultrasonic wave, capacitance change, air pressure, macromolecules (e.g., ICPF: Ionic Conducting Polymer Film), or the like. By combining various types of actuators, it is possible to produce a wide variety of tactile feelings, compared to the use of a single type actuator.

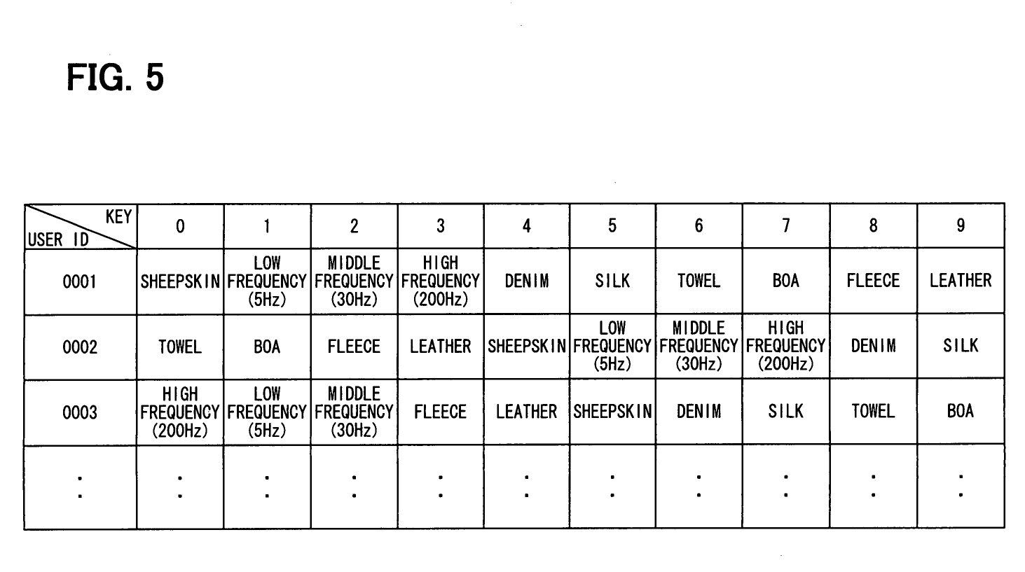

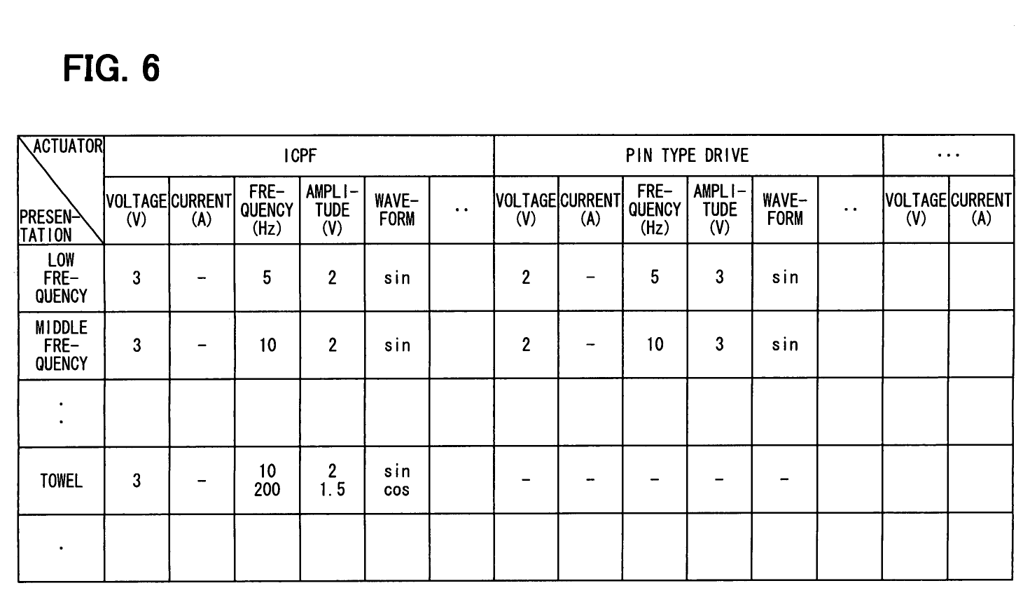

For example, as shown in FIG. 5, the identification apparatus may be configured to produce ten types of tactile feelings, which are for example a sheepskin feeling, a denim feeling, a silk feeling, a towel feeling, a boa feeling, a fleece feeling, and a leather feeling in addition to the above-described three types of the tactile feelings (i.e., a high frequency, a middle frequency, a low frequency). The above tactile feelings may be produced by a tactile actuator 30 that has multiple actuator elements, which are a macromolecule gel actuator (i.e., ICPF), a pin type actuator, an ultrasonic vibration actuator or the like. For example, a control value for each actuator element (e.g., a voltage, a current, a frequency, amplitude, a wave form) is preliminarily set as shown in FIG. 6 to produce the corresponding tactile feeling.

When a correspondence relation between the ten kinds of tactile feelings and the numerals of “1” to “9” is stored for each user ID as shown in FIG. 5, even if the identification code is a four-digits number as similar as that according to the above embodiment, it is possible to provides the correspondence relation with much more kinds of maps than that according to the above embodiment. As a result, it becomes remarkably difficult to estimate the correspondence relation, and thus, it is possible to drastically improve security.

According to the identification apparatus of an example embodiment, the identification code is created in a random manner. Alternatively, the identification code is created in another manner; for example, the identification code is changed in a predermined order.

According to the identification apparatus of an example embodiment, identification is performed based on the identification code. Alternatively, the identification is performed in combination with another manner such as an ID card, fingerprint identification, voice identification, facial identification, or the like. According to the above manners, it is possible to further improve security.

According to the identification apparatus of an example embodiment, the monitor 20 has a touch-sensitive screen. Alternatively, the identification apparatus may be configured such that layout of the input keys 21 and the operation key can be free to be changed. According to the above configuration, it is possible to improve operability.

According to a first aspect of the present disclosure, an identification apparatus is provided. The identification apparatus includes an input unit capable of receiving an input operation, a tactile producing unit capable of producing multiple tactile information items different from each other, and a memory unit storing a correspondence relation between the multiple tactile information items and multiple information units. The multiple information units can be used for creating an identification code. The identification apparatus further includes a code creation unit, a tactile generation unit, and an identification unit. The code creation unit creates the identification code, which is unfixed one and may change every operation, by combining the information units. Further, the tactile generation unit causes the tactile producing unit to produce one or more of the tactile information items that represent the identification code created by the code creation unit, based on the correspondence relation stored in the memory unit. Further, the identification unit performs identification by determining whether the identification code that is created by the code creation unit is consistent with the identification code that is actually input through the input unit in response to the producing of the one or more of the tactile information items representing the identification code created by the code creation unit.

According to the above identification apparatus, it is possible to identify a user who knows the correct correspondence relation between the tactile information items and the information units. In particular, the tactile information item that is produced and presented by the tactile producing unit is not able to be surreptitiously watched, or in other words, cannot be discovered by visual sensation. Therefore, even if the input operation of the identification code is surreptitiously watched, the correspondence relation between the tactile information items and the information units cannot be discovered. By performing identification with the dynamical or unfixed identification code, it is possible to prevent a stranger from being successfully identified as a proper user.

The identification apparatus may create the identification code by randomly combining the information units. According to the above manner, it is possible to make it difficult to estimate the correspondence relation between the tactile information items and the information units.

In the identification apparatus, the memory unit may store the correspondence relation having multiple maps for making connection between the multiple tactile information items and the multiple information units, the multiple maps being different from each other.

Many kinds of the information units may be preferable in that an identification code can be shortened and estimation of the correspondence relation can be difficult. In such cases, it may be necessary to increase types of the tactile information items. Accordingly, the identification apparatus may be configured such that the tactile producing unit has many types of actuators. Such an identification apparatus can produce various types of tactile information items more than an identification apparatus having one type actuator.

The identification apparatus may further include an information display unit that is capable of displaying the multiple information units. The identification apparatus may further include a correspondence notification unit that is configured to cause the information display unit to display the plurality of information units in a predetermined order while causing the tactile producing unit to produce the plurality of tactile information items, so that one of the plurality of information units that is presently being displayed corresponds to one of the plurality of the tactile information items that is presently being produced. According to the above identification apparatus, it is possible to notify a user of the correct correspondence relation between the tactile information items and the information items in, for example, a user registration.

According to a second aspect of the present disclosure, an identification method is provided. The identification method includes: dynamically creating an identification code by combining multiple information items; producing one or more of multiple tactile information items that represent the created identification code, based on a correspondence relation between the multiple tactile information items and the multiple information units; and performing identification by determining whether the created identification code is consistent with the identification code that is actually input in response to the producing of the one or more of the multiple tactile information items that represent the created identification code. The above method can provide advantages as similar as the above identification apparatus can provide.

While the invention has been described above with reference to various embodiments thereof, it is to be understood that the invention is not limited to the above described embodiments and construction. The invention is intended to cover various modification and equivalent arrangements. In addition, while the various combinations and configurations described above are contemplated as embodying the invention, other combinations and configurations, including more, less or only a single element, are also contemplated as being within the scope of embodiment.

What is claimed is:

1. An identification apparatus comprising:
an input unit capable of receiving an input operation;
a tactile producing unit capable of producing a plurality of tactile information items different from each other;
a memory unit storing a correspondence relation between the plurality of tactile information items and a plurality of information units;
a code creation unit capable of creating an identification code, which is unfixed, by combining the plurality of information units;
a tactile generation unit configured to cause the tactile producing unit to produce one or more of the plurality of tactile information items that represents the identification code created by the code creation unit, based on the correspondence relation stored in the memory unit; and
an identification unit configured to perform identification based on determining whether the identification code that is created by the code creation unit is equal to the identification code that is actually input through the input unit in response to the producing of the one or more of the plurality of tactile information items representing the identification code created by the code creation unit.

2. The identification apparatus according to claim 1, wherein:
the code creation unit creates the identification code by randomly combining the plurality of information units.

3. The identification apparatus according to claim 1, wherein:
the correspondence relation stored in the memory unit has a plurality of maps for making connection between the plurality of tactile information items and the plurality of information units; and
the plurality of maps are different from each other.

4. The identification apparatus according to claim 1, wherein:
the tactile producing unit has a plurality of actuators different from each other.

5. The identification apparatus according to claim 1, further comprising:
an information display unit capable of displaying the plurality of information units; and
a correspondence notification unit configured to cause the information display unit to display the plurality of information units in a predetermined order while causing the tactile producing unit to produce the plurality of tactile information items, so that one of the plurality of information units that is presently being displayed corresponds to one of the plurality of the tactile information items that is presently being produced.

6. An identification method comprising:
creating an identification code, which is unfixed, by combining a plurality of information items;
producing one or more of a plurality of tactile information items that represents the created identification code, based on a correspondence relation between the plurality of tactile information items and the plurality of information units; and
performing identification based on determining whether the created identification code is equal to the identification code that is actually input in response to the producing of the one or more of the plurality of tactile information items that represents the created identification code.

7. The identification method according to claim 6, wherein
the identification code is created by randomly combining the plurality of information items.

8. The identification method according to claim 6, wherein:
the correspondence relation has a plurality of maps for making connection between the plurality of tactile information items and the plurality of information units; and
the plurality of maps is different from each other.

9. The identification method according to claim 6, wherein:
the plurality of tactile information items is produced by a plurality of actuators different from each other.

10. The identification method according to claim 6, further comprising:
notifying the correspondence relation, which includes:
displaying the plurality of information units in a predetermined order while producing the plurality of tactile information items, so that one of the plurality of information units that is presently being displayed corresponds to one of the plurality of the tactile information items that is presently being produced.
